(19) United States
(12) Patent Application Publication
(10) Pub. No.: US 2014/0248438 A1
(43) Pub. Date: Sep. 4, 2014

(54) METHOD OF COATING MOLDED METALS FOR ABRASION RESISTANCE

(71) Applicants: Danliang Jin, The Woodlands, TX (US); Robert J. Petcavich, The Woodlands, TX (US)

(72) Inventors: Danliang Jin, The Woodlands, TX (US); Robert J. Petcavich, The Woodlands, TX (US)

(73) Assignee: Uni-Pixel Displays, Inc., The Woodlands, TX (US)

(21) Appl. No.: 13/784,745

(22) Filed: Mar. 4, 2013

(51) Int. Cl. B05D 3/14; B05C 9/10; B05C 9/12; B05D 3/06

(52) U.S. Cl. CPC B05D 3/142; B05D 3/067; B05C 9/10; B05C 9/12
USPC 427/508; 427/327; 427/534; 118/72; 118/620; 118/641

(57) ABSTRACT

A method of coating molded metals includes cleaning a molded metal, coating the molded metal with a coating, and curing the coated molded metal. The coating includes monofunctional monomers, multifunctional monomers, and acrylic oligomers. A molded metal coating application system includes a conveyor configured to transport a molded metal. A cleaning stage is configured to clean the molded metal. A coating stage is configured to deposit a coating on the molded metal. A curing stage is configured to cure the deposited coating on the molded metal. The coating includes monofunctional monomers, multifunctional monomers, and acrylic oligomers.

### BACKGROUND OF THE INVENTION

The industrial design of cases has become increasingly important in the area of consumer electronics. Cases provide protection to electronic devices placed within them, provide an aesthetic appearance, and, in some instances, identify a brand or product. The industrial design of cases is impacted by the availability of materials, the cost of materials, the difficulty of fabrication, and the cost of fabrication. In addition, the useful life or desirability of a case may degrade based on environmental factors or usage profiles.

### BRIEF SUMMARY OF THE INVENTION

According to one aspect of one or more embodiments of the present invention, a method of coating molded metals includes cleaning a molded metal, coating the molded metal with a coating, and curing the coated molded metal. The coating includes monofunctional monomers, multifunctional monomers, and acrylic oligomers.

According to one aspect of one or more embodiments of the present invention, a molded metal coating application system includes a conveyor configured to transport a molded metal. A cleaning stage is configured to clean the molded metal. A coating stage is configured to deposit a coating on the molded metal. A curing stage is configured to cure the deposited coating on the molded metal. The coating includes monofunctional monomers, multifunctional monomers, and acrylic oligomers.

Other aspects of the present invention will be apparent from the following description and claims.

### BRIEF DESCRIPTION OF THE DRAWINGS

FIG. 1 shows a coating application system in accordance with one or more embodiments of the present invention.

FIG. 2 shows a molded metal with a scratch and abrasion resistant coating layer in accordance with one or more embodiments of the present invention.

FIG. 3 shows a pencil hardness test in accordance with one or more embodiments of the present invention.

FIG. 4 shows a method of coating a molded metal in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

In one or more embodiments of the present invention, one or more metals may be used to form a protective case. Aluminum is commonly used because of its physical properties, abundant availability, and price. Aluminum may be anodized through an electrolytic passivation process that increases the thickness of the natural oxide layer on the surface of the metal. Aluminum is anodized by immersing the aluminum in an acid electrolyte bath and passing an electric current through the medium. Through this process, aluminum oxide is integrated with the underlying aluminum substrate, thus preventing peeling. However, the anodizing process is expensive and difficult to implement and the aluminum is still susceptible to scratching. Magnesium is another metal commonly used for casings because of its ability to be injection molded, its physical properties, and mechanical properties. Magnesium has a high strength to weight ratio that makes it an ideal metal for automotive and aerospace applications. However, magnesium is highly susceptible to corrosion and scratching.

In one or more embodiments of the present invention, a method and system for coating molded metals, including aluminum and magnesium, provides a scratch and abrasion resistant coating on molded metals with a pencil surface hardness greater than 6H.

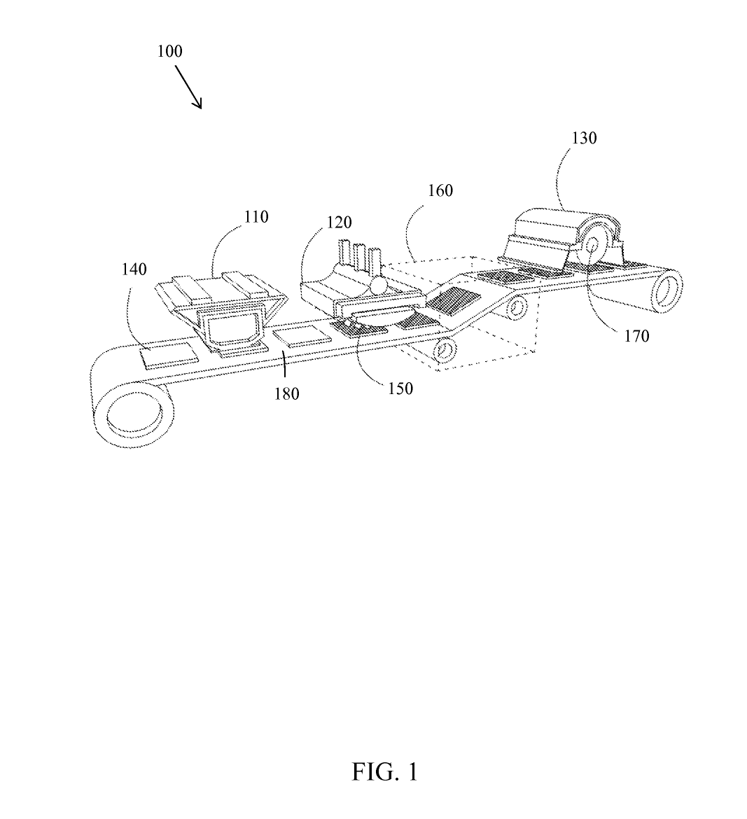

FIG. 1 shows a coating application system 100 in accordance with one or more embodiments of the present invention. In one or more embodiments of the present invention, coating application system 100 may include a cleaning and preparation stage, a coating deposition stage, and a curing stage. In one or more embodiments of the present invention, a molded metal 140 may proceed through the stages of coating application system 100 in sequence. In one or more embodiments of the present invention, molded metal 140 may be aluminum or magnesium. In one or more embodiments of the present invention, molded metal 140 may be an aluminum alloy. In one or more embodiments of the present invention, molded metal 140 may be an magnesium alloy. In one or more embodiments of the present invention, molded metal 140 may be an aluminum-magnesium alloy. One of ordinary skill in the art will recognize that other molded metals may be used in accordance with one or more embodiments of the present invention.

The coating application system 100 may include a cleaning and preparation stage that cleans the surface of molded metal 140 prior to coating. In one or more embodiments of the present invention, the cleaning and preparation stage may be a corona treatment module 110. In one or more embodiments of the present invention, corona treatment module 110 may be used to remove small particles, oils, and/or grease from molded metal 140. In addition, corona treatment module 110 may be used to increase surface energy and obtain sufficient wetting and adhesion of molded metal 140. As molded metal 140 passes through corona treatment module 110, high frequency electric discharges are applied to the surface of molded metal 140 forming open ends and free valences if there are organic molecules covering the surface. The free valences have the capacity to form carbonyl groups with the atoms from the ozone created by the electric discharge and improves adhesion. Generally, the more power/electrons, the shorter the molecular chains and more adhesion areas, hence higher surface energy. In one or more embodiments of the present invention, the intensity level of corona treatment module 110 may range between approximately 20 Dynes per centimeter to approximately 95 Dynes per centimeter. One of ordinary skill in the art will recognize that other cleaning and preparation modules and processes may be used in accordance with one or more embodiments of the present invention.

After cleaning, the coating application system 100 may include a coating stage that applies a scratch and abrasion resistant coating to the surface of molded metal 140. In one or more embodiments of the present invention, the coating stage may be a spray coating module 120. In one or more embodiments of the present invention, spray coating module 120 may spray a scratch and abrasion resistant coating formulation onto molded metal 140 forming a precise and conformal scratch and abrasion resistant coating layer 150. In one or more embodiments of the present invention, coating layer 150 may have a thickness in a range between approximately 1 micron to approximately 50 microns on molded metal 140. In one or more embodiments of the present invention, coating layer 150 may have a thickness in a range between approximately 5 microns to approximately 50 microns on molded metal 140. In one or more embodiments of the present invention, coating 150 may have a pencil hardness greater than 6H. In one or more embodiments of the present invention, spray coating module 120 may atomize coating 150 at a spray nozzle by pressure or ultrasound and then a gas may direct coating 150 towards molded metal 150.

In one or more embodiments of the present invention, coating 150 may be composed of monofunctional monomers, multifunctional monomers, and acrylic oligomers. In one or more embodiments of the present invention, coating 150 may be composed of solid content with a concentration by weight of approximately 70% to approximately 80%, a photo-initiator concentration in a range between approximately 1% to approximately 6%, and a solvent concentration in a range between approximately 10% to approximately 30% to regulate viscosity. In one or more embodiments of the present invention, coating 150 may be composed of 100% solid content. The addition of a solvent to coating 150 solution does not affect the properties of the coating because it evaporates after application and may eliminate any residuals left after cleaning Generally, when 100% solid content is used, a thickness of coating 150 after deposition and curing remains substantially the same. When a solvent is used, the thickness of coating 150 after curing may be reduced by solvent concentration. For example, if coating 150 has a thickness of 20 microns at deposition and a concentration of 20% solvent, the thickness may be reduced by 20% after curing.

In one or more embodiments of the present invention, pigments may be added as fillers into the formulation of coating 150 to achieve different colors or optical reflectivity effects. In one or more embodiments of the present invention, pigments may have a concentration by weight in a range between approximately 0.1% to approximately 5% of the formulation of coating 150. In one or more embodiments of the present invention, suitable pigments may include metallic flakes or pearlescent flakes.

In one or more embodiments of the present invention, the coating stage may be a slot die coating module (not shown). Slot die coating squeezes out coating 150 by pressure or gravity onto the moving surface of molded metal 140 forming a uniform layer. In one or more embodiments of the present invention, the coating stage may be a spin coating module (not shown). Spin coating distributes coating 150 over molded metal 140 by centrifugal force. In one or more embodiments of the present invention, the coating stage may be a dip coating module (not shown). Dip coating would require that molded metal 140 be dipped in a well of coating 150. In one or more embodiments of the present invention, the coating stage may be a brushing module (not shown). Brushing uses a brush saturated with coating 150 to apply a layer of coating 150 on molded metal 140. One of ordinary skill in the art will recognize that other coating modules and processes may be used in accordance with one or more embodiments of the present invention.

After coating, the coating application system 100 may include a transition zone. In one or more embodiments of the present invention, molded metal 140 with applied coating 150 may pass through transition zone 160 for a time in a range between approximately 5 seconds to approximately 300 seconds. The temperature may be in a range between approximately 20 degrees Celsius to approximately 30 degrees Celsius. In one or more embodiments of the present invention, transition zone 160 may allow for proper wetting of coating 150 across the surface of molded metal 140.

The coating application system 100 may include a curing stage. In one or more embodiments of the present invention, the curing stage may be a UV curing module 130. In one or more embodiments of the present invention, after passing through transition zone 160, molded metal 140 with applied coating 150 may pass through UV curing module 130. UV curing module 130 includes an oxygen free zone where a UV light source 170 may cure coating 150. Curing speed is critical for obtaining proper cross-linked densities. The reaction of monomers into a cross-linked polymer structure may occur in a short period while coating 150 is in a liquid state, thereby allowing monomers to move around and achieve more efficient cross-linking UV light source 170 may have a wavelength in a range between approximately 280 nanometers to approximately 480 nanometers with a target intensity in a range between approximately 0.5 Joules per centimeter squared to approximately 20 Joules per centimeter squared.

In one or more embodiments of the present invention, the curing stage may be an electron beam curing module (not shown). Electron beam curing applies an electric discharge to cure coating 150 and allows for the formation of a cross-linked polymer structure. Electron beam curing uses highly energetic electrons at controlled doses to quickly polymerize and cross-link polymeric materials. When electron beam curing is used, there is no need for an initiator within coating 150 as the electrons within the solution serve as initiators. Electron beam doses applied to coating 150 may range between approximately 0.5 Megarads to approximately 5 Megarads, while the exposure time may be in a range between approximately 0.01 seconds to approximately 5 seconds. In one or more embodiments of the present invention, the curing stage may be a thermo curing module (not shown). Thermo curing applies heat radiation within a temperature gradient that distributes heat across three different temperature stages that may range from 70 degrees Celsius to 120 degrees Celsius to 200 degrees Celsius. One of ordinary skill in the art will recognize that other curing modules and processes may be used in accordance with one or more embodiments of the present invention.

In one or more embodiments of the present invention, molded metal 140 may proceed through the stages of coating application system 100 on conveyor 180. In one or more embodiments of the present invention, molded metal 140 may proceed through the stages of coating application system 100 at a speed in a range between approximately 10 feet per minute to approximately 1000 feet per minute. In one or more embodiments of the present invention, molded metal 140 may proceed through the coating application system 100 at a speed in a range between 200 feet per minute and 400 feet per minute allowing for more accurate control of viscosity and thickness of scratch and abrasion resistant coating 150.

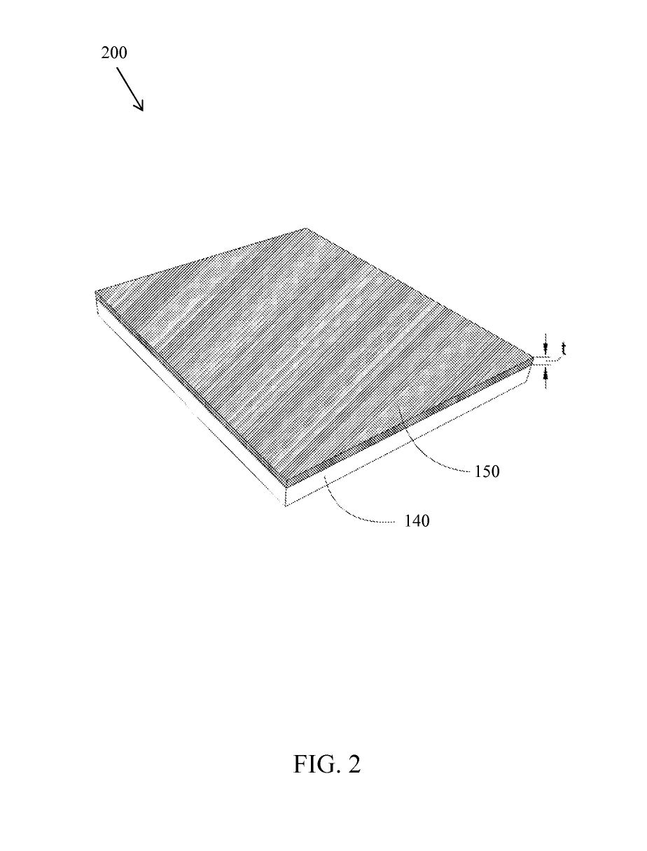

FIG. 2 shows a molded metal with a scratch and abrasion resistant coating layer 200 in accordance with one or more embodiments of the present invention. A scratch and abrasion resistant coating layer 150 may be deposited on molded metal 140 by coating application system 100. In one or more embodiments of the present invention, the scratch and abrasion resistant coating layer 150 may have a thickness, t, in a range between approximately 5 microns to approximately 50 microns. One or ordinary skill in the art will recognize that the thickness may vary in accordance with one or more embodiments of the present invention.

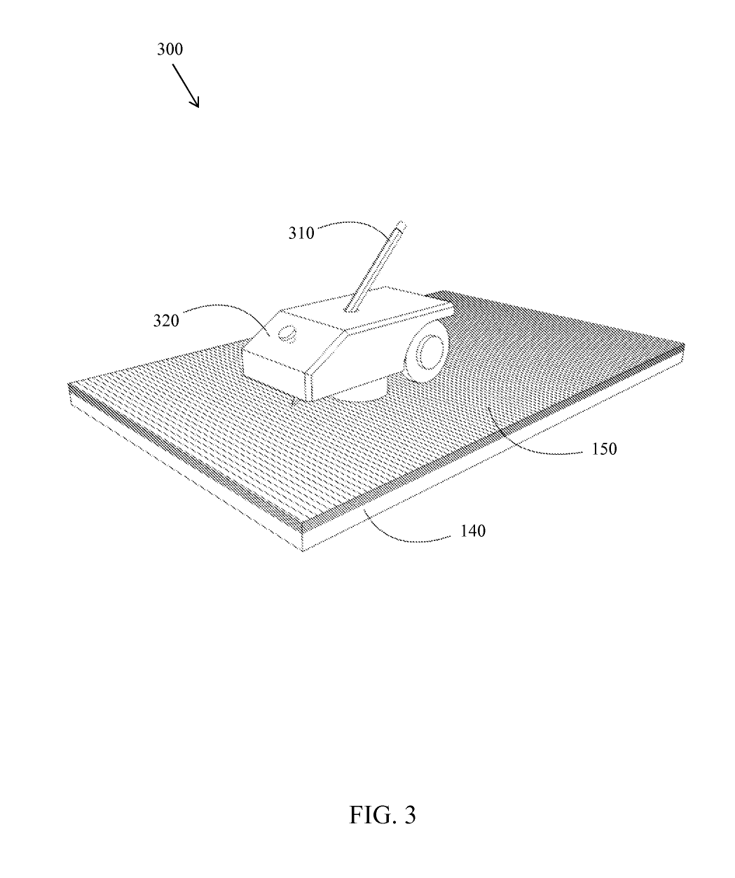

FIG. 3 shows a pencil hardness test 300 in accordance with one or more embodiments of the present invention. The pencil hardness test may be used to determine the hardness of scratch and abrasion resistant coating 150 on molded metal 140. A first pencil 310 is selected from a set of pencils that exhibit a hardness in an extended range, from hard to soft, of 9H to 9B. The selected pencil 310 is loaded into measuring cart 320. The measuring cart 320 positions selected pencil 310 at an angle and applies a constant force of approximately 7.5 Newtons. With the selected pencil 310 loaded into measuring cart 320, measuring cart 320 is moved across the surface of scratch and abrasion resistant coating 150. If selected pencil 310 leaves a scratch, then the next softer pencil 310 is used and the process is repeated. The hardness of the first pencil 310 that does not leave a mark is considered the pencil hardness of scratch and abrasion resistant coating 150 on molded metal 140. In one or more embodiments of the present invention, the pencil hardness test may be the American Society for Testing and Materials D3363 test. In one or more embodiments of the present invention, coating 150 may have a pencil hardness greater than 6H.

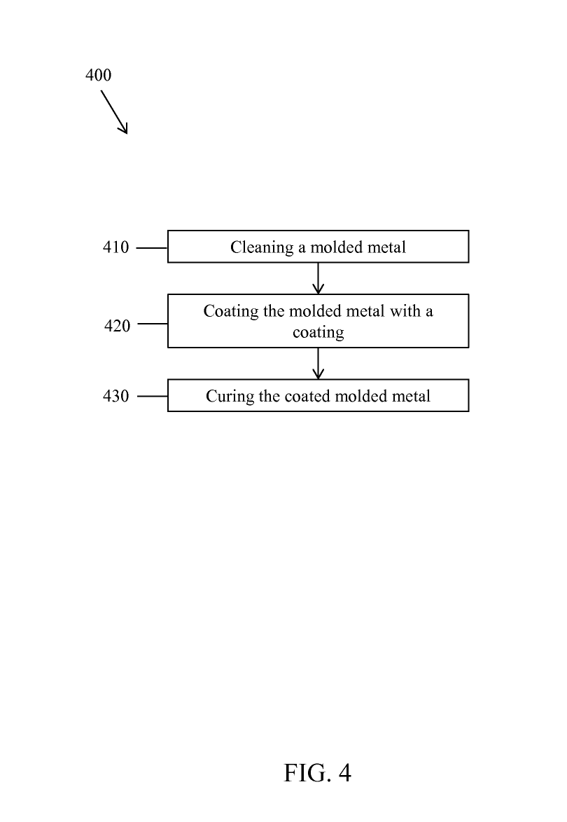

FIG. 4 shows a method of coating a molded metal in accordance with one or more embodiments of the present invention. In one or more embodiments of the present invention, the method of coating a molded metal may be performed by the coating application system 100.

In step 410, the surface of a molded metal may be cleaned. In one or more embodiments of the present invention, the molded metal may be aluminum or magnesium. In one or more embodiments of the present invention, the cleaning may be a corona treatment process performed by a corona treatment module. In one or more embodiments of the present invention, the corona treatment process may be used to increase surface energy and obtain sufficient wetting and adhesion of molded metal. In one or more embodiments of the present invention, the intensity level of a corona treatment process may range between approximately 20 Dynes per centimeter to approximately 95 Dynes per centimeter. One of ordinary skill in the art will recognize that other cleaning and preparation processes may be used in accordance with one or more embodiments of the present invention.

In step 420, the molded metal may be coated with a coating. In one or more embodiments of the present invention, the coating may be a spray coating process performed by a spray coating module. In one or more embodiments of the present invention, the spray coating process may spray a scratch and abrasion resistant coating formulation onto the molded metal forming a precise and conformal scratch and abrasion resistant coating layer. In one or more embodiments of the present invention, the coating layer may have a thickness in a range between approximately 1 micron to approximately 50 microns on the molded metal. In one or more embodiments of the present invention, the coating layer may have a thickness in a range between approximately 5 microns to approximately 50 microns on molded metal 140. In one or more embodiments of the present invention, coating 150 has a pencil hardness greater than 6H. In one or more embodiments of the present invention, the spray coating process may atomize the coating at a spray nozzle by pressure or ultrasound and then a gas may direct the coating towards the molded metal. In one or more embodiments of the present invention, the coating may be a slot die coating process, a spin coating process, a dip coating process, or a brushing process. One of ordinary skill in the art will recognize that other coating processes may be used in accordance with one or more embodiments of the present invention.

In step 430, the coated molded metal may be cured. In one or more embodiments of the present invention, the curing may be a UV curing process performed by a UV curing module. In one or more embodiments of the present invention, a UV curing process includes an oxygen free zone where a UV light source may cure the coating on the molded metal. Curing speed is critical for obtaining proper cross-linked densities. The reaction of monomers into a cross-linked polymer structure may occur in a short period while the coating is in a liquid state, thereby allowing monomers to move around and achieve more efficient cross-linking In one or more embodiments of the present invention, a curing speed of the curing process may be controlled to achieve a target cross-linked density. The UV light source may have a wavelength in a range between approximately 280 nanometers to approximately 480 nanometers with a target intensity in a range between approximately 0.5 Joules per centimeter squared to approximately 20 Joules per centimeter squared. In one or more embodiments, the molded metal may be transported on a conveyor at a speed in a range between approximately 200 feet per minute to approximately 400 feet per minute.

Advantages of one or more embodiments of the present invention may include one or more of the following:

In one or more embodiments of the present invention, the method of coating molded metals produces a coating that is scratch resistant.

In one or more embodiments of the present invention, the method of coating molded metals produces a coating that is abrasion resistant.

In one or more embodiments of the present invention, the method of coating molded metals produces a coating that is corrosion resistant.

In one or more embodiments of the present invention, the method of coating molded metals produces a coating with a pencil hardness greater than 6H.

In one or more embodiments of the present invention, the method of coating molded metals provides an efficient way to coat magnesium.

In one or more embodiments of the present invention, the method of coating molded metals provides an efficient way to coat injection molded metals.

In one or more embodiments of the present invention, the method of coating molded metals allows for the production of consumer electronics devices that are lightweight.

In one or more embodiments of the present invention, the method of coating molded metals allows for the production of consumer electronics devices that are cost efficient.

In one or more embodiments of the present invention, pigment may be added to a coating formulation to produce a coating with color.

In one or more embodiments of the present invention, pigment may be added to a coating formulation to produce a coating with optical reflectivity effects.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

1. A method of coating molded metals comprising:
cleaning a molded metal;
coating the molded metal with a scratch and abrasion resistant coating; and
curing the coated molded metal,
wherein the coating comprises monofunctional monomers, multifunctional monomers, and acrylic oligomers, and
wherein the coating has a pencil hardness greater than 6H.

2. The method of claim 1, wherein the coating has a thickness in a range between approximately 1 micron to approximately 50 microns.

3. (canceled)

4. The method of claim 1, wherein the molded metal comprises aluminum.

5. The method of claim 1, wherein the molded metal comprises magnesium.

6. The method of claim 1, wherein the cleaning comprises a corona treatment process.

7. The method of claim 1, wherein the coating comprises a spray coating process.

8. The method of claim 1, wherein the curing comprises a UV curing process.

9. The method of claim 1, wherein a curing speed of the curing is controlled to achieve a target cross-linked density.

10. The method of claim 1, wherein the molded metal is transported on a conveyor at a speed in a range between approximately 10 feet per minute to approximately 400 feet per minute.

11. A molded metal coating application system comprising:
a conveyor configured to transport a molded metal;
a cleaning stage configured to clean the molded metal;
a coating stage configured to deposit a scratch and abrasion resistant coating on the molded metal; and
a curing stage configured to cure the deposited coating on the molded metal,
wherein the coating comprises monofunctional monomers, multifunctional monomers, and acrylic oligomers, and
wherein the coating has a pencil hardness greater than 6H.

12. The system of claim 11, wherein the coating has a thickness in a range between approximately 1 micron to approximately 50 microns.

13. (canceled)

14. The system of claim 11, wherein the molded metal is aluminum.

15. The system of claim 11, wherein the molded metal is magnesium.

16. The system of claim 11, wherein the cleaning stage is a corona treatment module.

17. The system of claim 11, wherein the coating stage is a spray coating module.

18. The system of claim 11, wherein the curing stage is a UV curing module.

19. The system of claim 11, wherein a curing speed of the curing stage is controlled to achieve a target cross-linked density.

20. The system of claim 11, wherein the conveyor transports the molded metal at a speed in a range between approximately 10 feet per minute to approximately 400 feet per minute.

21. The method of claim 1, wherein the coating comprises solid content with a concentration by weight of approximately 70% to approximately 80%, a photo-initiator concentration in a range between approximately 1% to approximately 6%, and a solvent concentration in a range between approximately 10% to approximately 30%.

22. The system of claim 11, wherein the coating comprises solid content with a concentration by weight of approximately 70% to approximately 80%, a photo-initiator concentration in a range between approximately 1% to approximately 6%, and a solvent concentration in a range between approximately 10% to approximately 30%.
